(19) United States
(12) Patent Application Publication
(10) Pub. No.: US 2011/0295767 A1
(43) Pub. Date: Dec. 1, 2011

(54) INVERSE SOLUTION FOR STRUCTURED FINANCE

(76) Inventors: Sylvain Rock Raynes, Jackson Heights, NY (US); Ann Elaine Rutledge, Jackson Heights, NY (US)

(21) Appl. No.: 13/117,282

(22) Filed: May 27, 2011

Related U.S. Application Data
(60) Provisional application No. 61/348,964, filed on May 27, 2010.

(51) Int. Cl. G06Q 40/00

(52) U.S. Cl. 705/36 R

(57) ABSTRACT

A method, system, and computer program for solving the inverse problem through an iterative process whereby each iterative effectively solves one forward problem without having to sample the entire non-linear space. The method is a selective and iterative process for optimizing many variables that substantially achieves a global optimum solution. One particular process utilizes a neo-Darwinism method. Under this method, the sample space is iteratively analyzed via “mutations” to the value of the variable involved. Starting from a basic structure that is assumed sub-optimal, small variations or mutations are applied to each variable in turn, and those that are determined to improve the outcome value are kept. A better outcome value is determined to exist when a set of ratings is closer to the required set. Because the average rating is an invariant, the variable space is operated on throughout the process of looking for the combination of factors that will lead to the better outcome value.

### CROSS REFERENCE TO RELATED APPLICATIONS

This application claims priority under 35 U.S.C. §119(e) to provisional patent application Ser. No. 61/348,964 filed May 27, 2010, the disclosure of which is hereby incorporated by reference.

### STATEMENT REGARDING FEDERALLY SPONSORED RESEARCH OR DEVELOPMENT

N/A

### BACKGROUND OF THE INVENTION

Structured finance is a financing technique in which specific assets are placed in a trust to isolate them from the bankruptcy risk of the entity that originated them. See also example of calculations in Structured Finance U.S. Pat. No. 7,346,750 Structured finance is known to be a market in which all parties rely to a great extent on valuation ratings and rating announcements to understand the associated credit risks and sources of protection in structured securities, e.g., asset-backed commercial paper (ABCP), asset-backed securities (ABS), mortgage-backed securities (MBS), collateralized bond obligations (CBO), collateralized loan obligations (CLO), collateralized debt obligations (CDO), structured investment vehicles (SIV), derivatives products company (DPC), synthetic CLOs, CBOs of ABS, and so forth (collectively “structured finance”).

Structured finance results from the sale of receivables to a special purpose vehicle created solely for this purpose, e.g., an asset pool. Typically, securities backed by the receivables in the trust pool are separated into one or more “tranches” or “classes” and sold as such. Each tranche has its own characteristics, payment priorities, and, accordingly, varying risk profiles and payment expectations as a function of the potential delinquencies/defaults of the various receivables and other assets in the pool. By convention, the senior tranche usually has the lowest risk.

In structured finance, rating agencies are usually faced with what is known as the “forward problem”. More specifically, various asset-based structures proposed by investment banks are rated before they are sold. However, restructuring solutions are not proposed because sufficient compensation for the time and potential liability of providing such solutions are not available.

Bankers, investors, and analysts prefer that a given set of known ratings are salable into the capital markets. However, sufficient information regarding the ratings process to provide guidance for the desired outcome is generally not available at the time of sale. Consequently, the rating process remains iterative, time-consuming, and opaque to bankers and rating analysts. As a result, bankers and rating analysts exchange various re-incarnations of the asset-backed structure, hoping to “converge” to the requested ratings.

In its purest form, the basic characteristic of structured finance is that of a zero-sum game, which is to say that, in a world where multiple securities are issued from a common asset pool, it is impossible for one security holder to be better off without making another security holder worse off because all security holders share in a single set of cash flows. Accordingly, the only way to make all security holders better off simultaneously is to assume that the aggregate cash flow to be expected from the pool of assets is somehow better than previously thought. Accordingly, bankers, ratings analysts, and investors desire to solve the problem of structuring deals already rated. This is the “inverse problem”.

A major stumbling block of optimization and the inverse problem within structured finance is that rating a security equates to an average reduction of yield that the security would experience over the universe of possibilities to be expected from asset performance. Moreover, if it is also assumed that an “ergodic” hypothesis holds, i.e. that temporal averages are equal to ensemble averages, then the same reduction of yield would be experienced by an investor holding a well-diversified portfolio of similarly-rated securities.

Within the universe of possibilities, the yield function is non-linear and the solution (r) to the following equation:

I=ΣᵢC(t(i))/(1+r)^{t(i)},

in which C(t(i)) is cash flow experienced at time t(i) and I is the initial investment. Non-linearity causes local optima to be globally sub-optimal in a multi-dimensional space. Disadvantageously, one cannot optimize one variable at a time and, hence, a more sophisticated technique is required.

If the entire multi-dimensional space of many variables were explored, the number of possible values would quickly exhaust the capabilities of even the fastest computers. Consequently, it would be desirable to provide a method, a processing engine, and a computer-executable program for solving the inverse problem in a fast and efficient manner and, furthermore, for solving the inverse problem while minimizing the necessary computational resources.

### BRIEF SUMMARY OF THE INVENTION

A method of and system and computer-executable program for solving the inverse problem through an iterative process is disclosed. Preferably, each iterative step effectively solves one forward problem without having to sample the entire non-linear space. Each forward-problem solution is itself the fixed point of every tranche in the offering. This method is a selective and iterative process for optimizing many variables and that substantially achieves a global optimum solution. More particularly, one such process comprises a neo-Darwinism method by which the sample space is iteratively analyzed via “mutations” to the value of the variable involved.

For example, starting from a basic structure, assumed sub-optimal, small variations or mutations, are applied to each variable in turn. Variable values that improve the outcome value are kept. Values that do not are rejected.

A better outcome value is determined to exist when a set of ratings is within a predetermined range of an average rating. Because the average rating is an invariant, the variable space is operated on throughout the process of looking for the combination of factors that will lead to a better outcome value. Alternatively, the same iterative convergence can be implemented using one of the few evolutionary techniques, such as genetic algorithms and neural networks, and that have become both popular and reliable over the past ten years in sparse domains of this type. These methods are well-known and are now used within large-scale financial and industrial settings like fraud detection and logistics management.

Other aspects, features and advantages of the present invention are disclosed in the detailed description that follows.

### BRIEF DESCRIPTION OF THE SEVERAL VIEWS OF THE DRAWING

The invention will be more fully understood by reference to the following detailed description of the invention in conjunction with the drawings, of which:

FIG. 1 illustrates a process for determining the inverse solution problem according to an embodiment of the present invention;

FIG. 2 illustrates a flow chart of a process for solving the inverse solution problem according to another embodiment of the present invention; and

FIG. 3 illustrates a computer system for performing the processes according to the embodiments of the present invention.

### DETAILED DESCRIPTION OF THE INVENTION

This application claims priority under 35 U.S.C. §119(e) to provisional patent application Ser. No. 61/348,964 filed May 27, 2010, the disclosure of which is hereby incorporated by reference. A method of, system for, and computer-executable program for solving the inverse problem are disclosed. The method, system, and program utilize an iterative process in which each iterative effectively solves one forward problem without having to sample the entire non-linear space. As a result, a global optimum solution is achieved or substantially achieved by optimizing the many variables.

According to the invention as claimed, an average rating of the securities in the transaction, i.e., a “feasible range”, is determined based on the assumption that the average rating of asset-backed securities is approximately constant for a given set of cash flow histories from an asset pool. Indeed, the average rating is approximately constant because non-linearity in the yield curve may introduce arbitrage possibilities of a second order as compared to the zero-sum game condition.

Under such assumptions, the average rating is an “invariant” of the structure. As a result, if the average rating is less than the required or desired average rating, the problem will turn out to be “ill-posed” rather than “well-posed” problems. “Ill-posed” problems are mathematical concepts that indicate that the problem as stated has no unique solution. This average rating is known from the very first iteration and this important condition, i.e., that the average rating remains constant, can be enforced without any optimization.

Accordingly, one or many of the initial conditions must be altered to solve any inverse problem that is ill-posed. An illustrative, non-exhaustive set of examples of the independent factors and conditions that may be altered are shown below in Table I.

TABLE I

1. Reduction or increase in tranche size
(such that the sum remains invariant).
2. Introduction of a spread capture trigger
into the structure where cash was formerly
allowed to escape, or where the trigger
reapportions cash between the tranches.
3. Introduction of a reserve account or
another form of credit enhancement.
4. Changes in the waterfall from sequential
to pari passu or from pro rata and pari
passu to pari passu but not pro rata.
5. Subordinate tranche lockout periods.
6. Various forms of asset-based or
liability-based triggers.
7. Servicing fee subordination where
appropriate.
8. Senior tranche “turbo” mechanism upon
breaching a trigger.
9. Other structure finance factors and
conditions.

Once a determination has been made that the problem is ill-posed, the next step reduces total issuance until a “well-posed” condition is satisfied. In contrast with “ill-posed” problems, “well-posed” problems are mathematical concepts for which there is a unique solution. Once this condition is satisfied, optimization can begin.

Those of ordinary skill in the art can appreciate that many other types of enhancements, factors or structural features can be introduced into asset-backed transactions. Moreover, the introduction of a reserve account can raise the rating of any class since the reserve account effectively increases the available cash over the life of the offering. Optimality will result if doing so—taking into account the cost of setting aside this cash at closing—would improve the combination of the average ratings and the issuer's net position through a possible arbitrage of the rating and yield scales.

After determining a “feasible range” as previously discussed, the solution to the inverse problem proceeds by exploring each factor in Table I in turn within its range of possible variations, while introducing small disturbances in the remaining factors in search of a globally-optimal solution. Small variations can be exploited through the neo-Darwinian solution method described in more detail hereinafter to achieve global optimality. Due to the non-linearity of the yield curve, it will generally be possible to achieve a slightly better result than a “feasible solution” found during the first step.

Although there is no guarantee that a global optimum will actually be found, each new iterate, i.e., “mutation”, can be analyzed to determine whether its result is better than the previous or existing result. If the mutation provides a better result, the previous result will be replaced with the result yielded by the new iterate, otherwise the mutation will be discarded. The solution procedure can then be halted at any time to retrieve the current optimal structure.

Each factor in the list in Table I is to be placed inside an iterative loop within which “mutated” levels can be sampled.

Each set of factors is then fed to the forward solution process for producing a set of results to be compared with the required set. The forward solution can be halted when a predetermined “figure of merit” is reached which can be stated in terms of a total cost of issuance, a total issued amount, maximum proceeds or some combination of these factors or others.

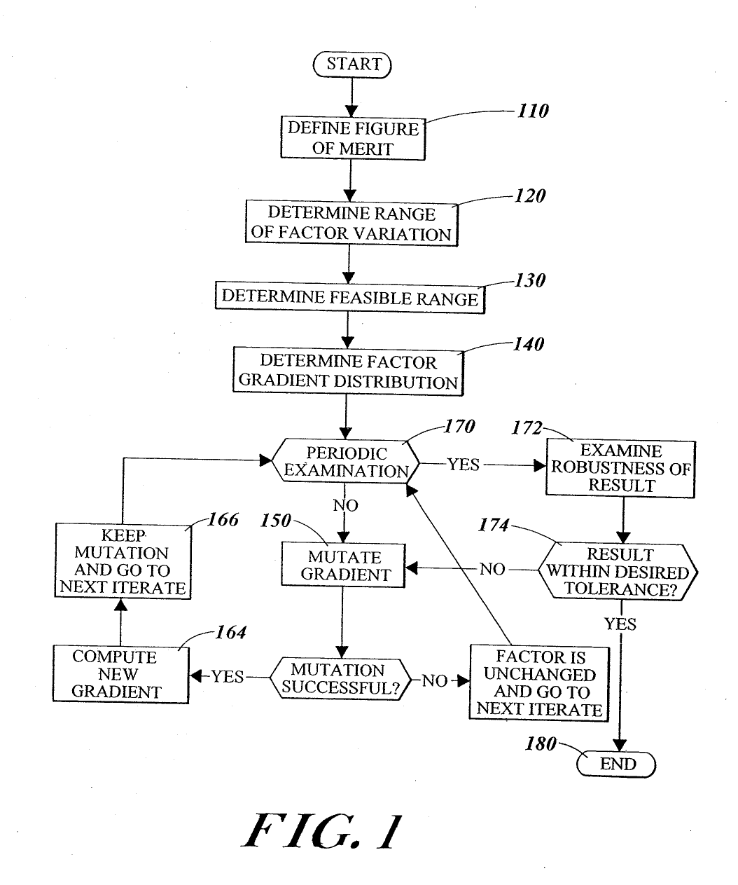

FIG. 1 illustrates a flowchart of a neo-Darwinism solution method according to an embodiment of the present invention. Initially, a figure of merit for the transaction is defined 110 in coordination with the issuer. In one example, the metric for determining this figure of merit is obtained by computing the average cost of issuance, the total proceeds, a weighted combination thereof, and the like. Those of ordinary skill in the art can appreciate that there are other variables that can be a figure or merit. These are used for illustrative purposes only and should not be construed as being limiting.

Next, a determination is made of the range of allowable variation 120 for each Table I factor. Subsequently, the feasible range is normalized 130, to facilitate embedding it into a binomial or another statistical distribution of discrete values. The mean of the binomial or other distribution can then be determined. The mean becomes the most like a priori range for the Table I factors.

More particularly, at step 130, a trial structure is obtained based on a prior transaction or a similar transaction executed by a comparable issuer. Using a trial issuance above the feasible range, which is usually limited by the condition of zero over-collateralization, an average tranche rating can be computed. If the average tranche rating is below the pre-established required rating, the issuance is reduced. However, if the average tranche rating is above the pre-established required rating, the issuance is increased until the discrepancy between the required rating and actual average rating is within a prescribed tolerance, e.g., five percent as a non-limiting example.

At step 140, the figure of merit for each factor is determined for at least two levels, which is to say, two distinct values of that factor, which are separated by a small distance, i.e., the algebraic difference between the two levels, to establish a gradient of the structure in that direction. This reveals the gradient of the impact of the factor. For example, a range from 0 to 1 can be partitioned into a probability distribution function given by the relative gradient probability distribution for the Table I factors. A Table I factor with a large gradient in its range will give rise to more frequent sampling of that factor, and vice versa. In practice, this procedure guarantees that the currently-most-sensitive factor is advantaged during the optimization without excluding the other factors completely. “Advantaged” means that the factor that changes the figure of merit the most per unit of change in such factor. i.e., the “currently-most-sensitive factor”, is changed more frequently in the search procedure, to identify the optimum along its axis.

At step 150, a non-linear space “loop structure” is entered. Each factor (which is listed generically as factor 1, factor 2, etc.) is mutated in turn and preserved only if it leads to a higher figure of merit when compared to the currently-most-sensitive factor. Factor sampling uses the binomial distribution defined above and the inverse cumulative distribution function method. The next iterate is defined as the previous iterate plus the binomial factor increase. The binomial factor can be negative, which indicates a binomial factor decrease, or positive, which indicates a binomial factor increase.

If a mutation is determined to be successful 160, i.e., well-posed, the relevant factor is retained at that value until its next mutation 166. If, on the other hand, the mutation is determined not to be successful 160, i.e., ill-posed, the factor value before the mutation is retained and another factor is tried 162.

More particularly, the gradient is re-computed 164 for each successful mutation and the gradient probability distribution is re-normalized 150 for the factor selection. Additionally, the factor value from the mutation is retained before proceeding to the next iterate 166. For example, a standard optimization method, e.g., the steepest descent or Newton-Raphson method, may be used to accelerate the search for the global optimum. The challenge is to find the optimum combination of factors, keeping in mind that a factor thought to be optimal at some level may turn out to be sub-optimal when other factors have been altered.

Each set of factor levels necessitates the solution of a forward problem. Each such solution requires the analysis of the exact structural details of the transaction, many of which may have changed since the last iteration.

By design, the solution procedure is halted periodically or after a pre-determined number of cycles 170. During such a halt, the resulting structure is examined for robustness by mutating each factor in turn using a larger difference 172. Thereafter, a determination is made 174 as to whether the range of possible improvement using one factor at a time variation is smaller than a specified value. If the criterion is satisfied, the method is stopped at 180. Otherwise, the method returns to the loop structure 150.

In one specific example of a method for solving the inverse solution problem according to an embodiment of the present invention, there will be an initial figure of merit generated which will establish the desired outcome for each issuer for the investment in pooled assets. For example, one set of situations may prefer early cash returns while another may be for maximum overall returns. Armed with this information, a desired or target rating and interest rate for each component or tranche of the investors can be pre-established.

Statistical analysis is then used to test the investment according to the rating targets of the financial institutions, e.g., insurance companies or retirement funds, doing the investing and to determine how closely the investment can be tailored to fit those targets. Because cash flow models cannot be solved for the desired output, information of the tranche rating, an iterative approach is undertaken by varying the output until convergence to the actual input factors is achieved.

The factors or variables available for adjustment in the effort to reach the targets are various and may change for each transaction or offering. One set of typical and non-limiting factors is shown in Table I. It is to be clearly understood that other factors may be selected due to the ability to control them for different deals.

With a set of factors available, the cash flow model is provided with starting values for each of the factors. Consider one such factor to be the factor size of each tranche in a two-tranche offering, e.g., typically one tranche has little risk and one tranche has high risk but a sizable return. Because the level of risk and possible level of gain are different for each tranche, there will be a greater factor size for the lower-risk tranche and a smaller factor size for the riskier one for a number of reasons not the least of which is the availability of accurate information on the probability of a high return. For exemplary purposes only a starting point for the tranche size factor could then be 90/10 for lower (Class A)/higher (Class B) risk, respectively. Initial values for the other factors will also be selected. Such initial values could be selected easily based on historical data from prior transactions, using a rule-of-thumb, and so forth.

The analysis begins by first running a statistical analysis of the cash flow model for the initial factor value selections. Then one factor is varied. Assuming it is the tranche size, it could typically be varied by 0.5, to say 90.5/9.5. The statistical iterative analysis is run again and the result normally provides a different set of ratings for each tranche. The first factor is then returned to its prior value and another factor is varied and the statistical iteration is converged again. This is repeated for all the factors, at which point a gradient is established as the slope of the curve represented by the cash flow model at those initial factor values.

The process is then repeated, moving each factor in the direction of the gradient. When this is accomplished, presumably the ratings will have improved. Where the determined gradient is relatively large, e.g., a steep slope, it may be desirable to make the step changes in the factors large so as to speed up the process. This is desirable because the process of convergence is very lengthy for even very fast computers given the number of factors and the need to have multiple evaluations for the convergence operation to reach an accurate end result.

Eventually a peak or maximum in the tranche ratings will result. However, given the complex non-linearity of the cash flow models, this may be only a local maximum. To account for this possibility, one of the factors is given a relatively large value change and the entire process is re-run to find a new local maximum. This large step of mutation is then repeated for each factor, not just once but as many times as the available time for computation will allow. Because of the significant time requirements, it may not be possible to assess all local maxima in order to find the best. Similarly no maximum may be high enough to justify the deal.

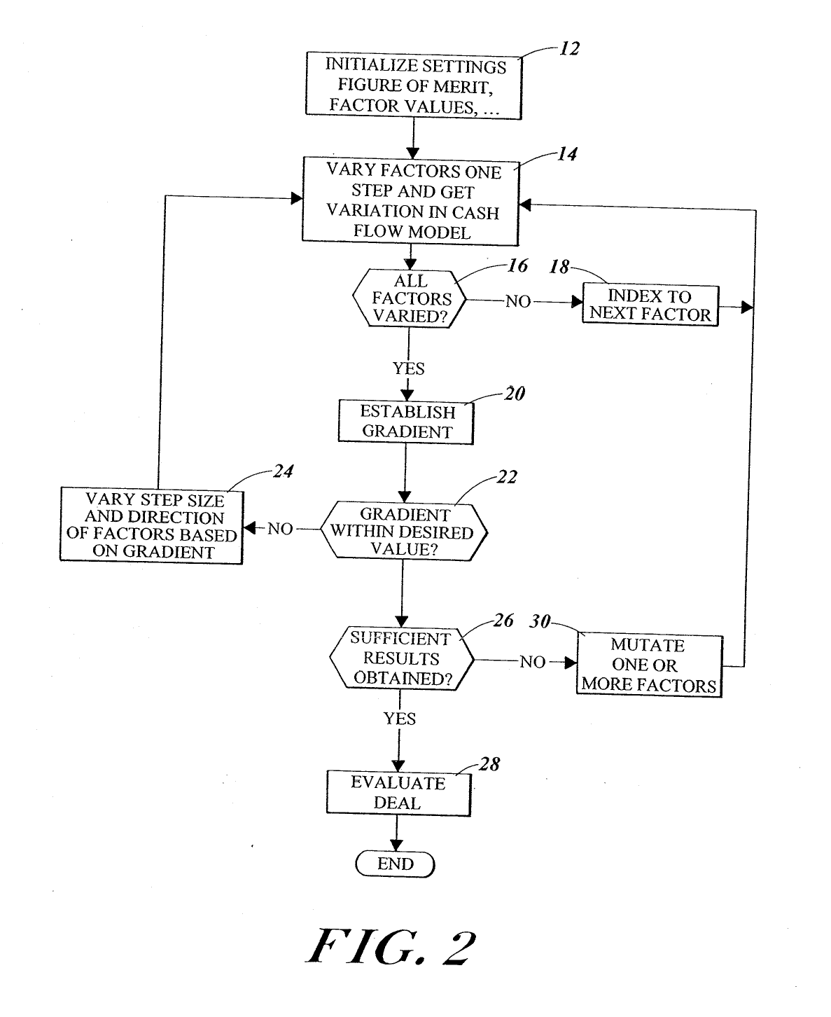

FIG. 2 shows the computer logic diagramatically in the form of a flow chart. While most of the steps are computer executed, some steps, e.g., the initializing step 12 and final determination step 22, can be performed by human means as well as artificially. The initializing step 12 accomplishes the formulation of the figure of merit and target ratings for the offering along with the number and approximate risk, starting values for the factors, and participation rules for the tranches. The processor uses an applicable cash flow model(s) and calculates an iterative determination of the effect on the ratings as defined in the cash flow model from a one-step move (out and back) in a first (or next) one of the several factors 14. Once that is done, a decision step 16 determines whether or not all of the factors have experienced the one-step evaluation of step 14. If the determination is that not all the factors have been moved, a subsequent step indexes or advances to the next factor in the list 18 and returns processing to step 14. As can be seen this accomplishes a one-step move in all the factors and provides the change in the rating information for each.

When all the factors have executed this one-step 16 and back move from the initial (or current) values, a subsequent step 20 establishes the gradient in the rating information for the various changes in factor value for each move. This is, in effect, a partial differential over each of the factors. In a subsequent decision step 22, the system determines whether or not the process has reached a suitable conclusion. Normally the process will loop through this decision 22 many times with a no determination, returning to the step 14 for another round of factor steps. The step size and direction is a function of the gradient so the iterative analysis moves each factor toward a higher or preferred rating outcome 24. For example, if the gradient is steep, the process may increase the step size.

If the gradient is small enough or time is short, the decision 22 may decide that the process had progressed far enough and determine whether it is time to quit 28 or to continue mutating factors 30. If the step 26 determines the process is finished, it proceeds to a deal evaluation step 28, which is largely human powered. In contrast, if the process is not yet done, a step 30 mutates one or more factors by stepping them a large distance compared to the small steps that had been taken previously in the changes of factor value.

The step size is large enough to give a high probability of moving out of the region of slope of a local maximum about which the cash flow model was used to reach to or nearly to the local maximum. The step is of a size that it is likely—though not certain—to reach the region of a separate local maximum that may be higher or lower. The mutation may by one, several or all factors at a time.

After the mutation 30, the entire process is repeated leading to finding the local maximum for the ratings by iterative analysis of the cash flow model(s). This process of mutation will also be made many times in the process of deal evaluation leading to several maxima and thus allowing selection of the highest or one of the highest thereof. As can be seen, there is an enormous amount of calculations in this process given the iterative nature of the models involved and the need to repeat the entire procedure a great many time for each maximum to be found. Only high capability computation equipment can be used for this to be done efficiently.

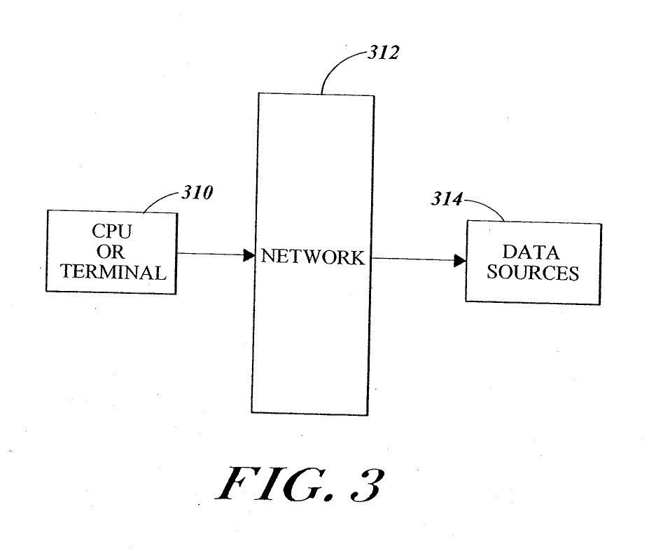

The invention is typically performed in a powerful computer environment given the number of iterations that are performed. As such, referring to FIG. 3, the system 300 includes one or more processors, central processing units (CPUs), and/or terminals 310 that are electronically- and operatively-coupled to a network 312, e.g., the World Wide Web, the Internet, a wide area network, a local area network, and the like. Each of the one or more processors, central processing units (CPUs), and/or terminals 310 is adapted to request and receive data from sources 314 via the network 312.

It will be apparent to those skilled in the art that other modifications to and variations of the above-described techniques are possible without departing from the inventive concepts disclosed herein. Accordingly, the invention should be viewed as limited solely by the scope and spirit of the appended claims.

What is claimed is:

1. A method for analyzing a financial investment to achieve a rating therefore characterized by at least one issuer, at least one investor, and a structure comprising one or more tranches, and a plurality of variable factors which affect a value of each tranche, the method comprising the steps of:
establishing a figure of merit as a target rating for the financial investment and a starting value for a set of some or all of said plurality of factors; and
applying said target rating and starting value to a processor memory;
Iteratively calculating in said processor an effect on investment rating for a predetermined step change in said set of some or all of said plurality of factors using a cash flow model to determine at least one local maximum for the rating;
wherein said step of iteratively calculating the effect on investment rating of the step change is performed via a solution of a single forward-problem solution which comprises a fixed point of a non-linear mapping function in a multi-dimensional Banach space whereby each dimension of the Banach space corresponds to one tranche in said structure, said structure progressing through a series of provisional structures with each iteration.

2. The method of claim 1, wherein said iteratively calculating step further includes:
making a step change in each of said factors in said set;
determining a gradient in the rating as a function of each factor in said set; and
repeating the iterative calculation with step changes in the direction of said gradient for each of said factors in said set.

3. The method of claim 1, wherein said iteratively calculating step includes the steps of:
after determination of said local maximum, making a change, in one or more factors of said set, sufficient for subsequent iterative calculations to reach a different local maximum; and
making said subsequent iterative calculations to reach said different local maximum.

4. The method of claim 3 further including the step of repeating said step of making said subsequent iterative calculation steps one or more times using a method selected from the group consisting of a neo-Darwinist mutation method, neural network method, and a genetic algorithms method.

5. The method of claim 4, wherein said repetition of said step of making said subsequent iterative calculations is terminated after an operator decision to stop said method.

6. The method of claim 2, wherein said step of iteratively calculating determines the local maximum as a condition wherein said gradient is below a predetermined level.

7. The method of claim 1, wherein said set includes all of said factors.

8. The method of claim 1, wherein each change in factor value is a function of a local gradient.

9. The method of claim 1, wherein there are plural tranches.

10. A method for giving advice on rating of an investment comprising the steps of:
receiving information about the investment; and
obtaining investment rating information resulting from performing the steps of claim 1.

11. A method for assessing a rating of a structured finance transaction associated with a pool of assets and defined by a plurality of variable factors and a cash flow model, the method comprising the steps of:
(a) initializing said plurality of variable factors and a figure of merit;
(b) varying each of said plurality of variable factors of the cash flow model;
(c) determining a gradient indicative of a size and direction of movement in response to said step (b);
(d) iteratively repeating said steps (b) and (c) until said gradient is less than a predetermined tolerance value;
(e) determining whether the rating is within said figure of merit;
(f) when the rating is determined to be outside of said figure of merit at said step (e), mutating at least one of said plurality of variable factors and repeating said steps (b)-(e); and
(g) when the rating is determined to be within said figure of merit at said step (e), evaluating the structure of rating results.

12. A computer program product for analyzing a financial investment characterized by at least one issuer, at least one investor, and a structure comprising one or more tranches, and a plurality of variable factors, the computer program in the form of computer readable media having a computer program stored thereon, the computer program being executable on a processor and comprising executable machine language or code for:
establishing a figure of merit as a target for the financial investment and a starting value for a set of some or all of said factors; and
iteratively calculating an effect on investment rating for a predetermined step change in said set of some or all of said plurality of factors using a cash flow model to determine at least a local maximum for the rating, wherein
calculating the effect on investment rating of the said step change is via a solution of a single forward-problem solution consisting of a fixed point of a non-linear mapping function in a multi-dimensional Banach space whereby each dimension of the Banach space corresponds to one tranche in said structure, said structure progressing through a series of provisional structures.

13. The program of claim 12 wherein the executable machine language or code for said iteratively calculating step further includes executable machine language or code for:
making a step change in each of said plurality of variable factors in said set;
determining a gradient in the rating as a function of each factor of said plurality of variable factors in said set; and
repeating the iterative calculation with step changes in the direction of said gradient for each of said plurality of variable factors in said set.

14. The program of claim 12 wherein executable machine language or code for said iteratively calculating step includes executable machine language or code for:
after determination of said local maximum, making a change, in one or more factors of said set, sufficient for subsequent iterative calculations to reach a different local maximum; and
making said subsequent iterative calculations to reach said different local maximum.

15. The program of claim 14 further including executable machine language or code for repeating said step of making said subsequent iterative calculations steps one or more times using a method selected from the group comprising a neo-Darwinist mutation method, a neural network method or a genetic algorithm method.

16. The program of claim 13, wherein executable machine language or code for repeating said step of making said subsequent iterative calculations includes executable machine language or code for terminating the same after an operator decision to stop.

17. The program of claim 14, wherein iteratively calculating determines a local maximum as a condition wherein said gradient is below a predetermined level.

18. The program of claim 12, wherein said set includes all of said factors.

19. The program of claim 12, wherein each change in factor value is a function of a local gradient.

20. A program for assessing a rating of a structured finance transaction associated with a pool of assets and defined by a plurality of variable factors and a cash flow model, the computer program in the form of computer readable media having a computer program stored thereon, the computer program being executable on a processor and comprising executable machine language or code for:
a) initializing said factors and a figure of merit;
b) varying each of said factors of the cash flow model;
c) determining a gradient indicative of the size and direction of movement in response to said step (b);
d) iteratively repeating said steps (b) and (c) until said gradient is less than a predetermined tolerance value;
e) determining whether the results of the rating are within said figure of merit;
f) when the results of the rating are determined to be outside of said figure of merit at said step (e), mutating at least one of said factors and repeating said steps (b)-(e); and
when the results of the rating are determined to be within said figure of merit at said step (e), evaluating the structure of the results.
